(19) United States
(12) Patent Application Publication
(10) Pub. No.: US 2008/0033913 A1
(43) Pub. Date: Feb. 7, 2008

(54) Techniques for Preventing Insider Theft of Electronic Documents

(76) Inventor: Michael L. Winburn, Indialantic, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/420,576

(22) Filed: May 26, 2006

(51) Int. Cl. G06F 17/30

(52) U.S. Cl. 707/3

(57) ABSTRACT

Techniques for protecting electronic documents from unauthorized access by insiders create a protected document fingerprint of each document to be protected and comparing a similar fingerprint of a suspected document or text. When the two fingerprints match to a certain degree of similarity, a security alert is activated. The techniques can be installed on devices in order to notify a security official, prevent an email from being sent; prevent a document from being printed, prevent packets from being forwarded, prevent copying of the suspect document to a removable medium and the like. A document fingerprint is created by algorithmically selecting words to be used in creating the fingerprint and algorithmically selecting characters from those words to be included in the document fingerprint. The techniques permit identification of text that comes from a protected document even if it has been retyped to rephrase the content of the protected document.

### STATEMENT REGARDING FEDERALLY FUNDED RESEARCH

The invention described herein was developed during performance of a phase two small business innovative research contract number FA8750-04-C-0074 administered by the Air Force Research Laboratory, Information Directorate (AFRL/IF).

### BACKGROUND OF THE INVENTION

1. Field of The Invention

The invention is directed to the field of electronic documents and, more particularly to the protection of electronic documents from theft by insiders.

2. Description of the Prior Art

A number of techniques are known for securing electronic documents. Many of these involve securing the facilities in which the electronic documents are kept. Other include encryption techniques of various sorts to insure that electronic documents do not fall into unauthorized hands. Other techniques utilize passwords and user identification techniques to insure that an unauthorized user does not obtain access to electronic documents. One such technique is found in U.S. Pat. No. 6,957,349 to Yutaka Yasukura entitled Method for Securing Safety of Electronic Information.

3. Problems of the Prior Art

The techniques of the prior art do not generally deal with the theft of sensitive information by trusted insiders or the more general problem of plagiarism. The problem of use by trusted insiders poses a significant vulnerability to government and commercial organizations. Because documents exist in electronic form, sensitive information can be easily distributed to unauthorized persons. Theft of sensitive information by a malicious insider can be accomplished with relative ease using email, portable hard drives, Internet applications, and write able media such as CD's, DVD's, floppy disc's, etc. Similarly, the problem of plagiarism can impact an institutions credibility with its constituency.

### BRIEF SUMMARY OF THE INVENTION

The invention protects electronic information from unauthorized removal by trusted insiders utilizing document fingerprints. The invention can also be used to identify possible plagiarism. Once under the protection of the inventive technology, any document that contains protected information can be identified and specific action on these documents can be controlled and restricted.

Once a document fingerprint of a document to be protected (protected document) is created, the invention easily recognizes any electronic information that contains text from the protected document. With this knowledge, applications applying the inventive technology can restrict the document from being emailed, copied to external media, transferred out of a controlled workspace or printed. For example, if a malicious insider copies (or retypes) sensitive information to the body of an email in attempts to send it to an external location, the invention;
1. Identifies that the email contains protected text;
2. Prevents the email from being sent; and
3. Generates a security alert.

This capability does not exist in any of the prior art.

### BRIEF DESCRIPTION OF THE DRAWINGS

FIG. 1 is a flow chart of a process for creating a document fingerprint in accordance with one aspect of the invention.

FIG. 2 is a flow chart of a process for selecting a word for use in creating a document fingerprint in accordance with one aspect of the invention.

FIG. 3 is an example of words selected from text to be fingerprinted using the process of FIG. 2.

FIG. 4 illustrates the process for selection of a character of a selected word for inclusion in a document fingerprint in accordance with one aspect of the invention.

FIG. 5 is a flow chart of a process for identifying whether a suspect document contains content from a protected document in accordance with one aspect of the invention.

FIGS. 6A and 6B show respective fingerprints from a protected document and a suspect document, respectively.

FIGS. 6C and 6D show the full text of a protected document and of a suspect document, respectively.

FIG. 7 is a flow chart of a full text similarity comparison used to confirm whether a suspect document contains sufficient information from a protected document to initiate a human review or to initiate other security actions.

FIG. 8 is a block diagram of an exemplary computing device used as part of a network architecture utilized in various embodiments of the invention.

### DETAILED DESCRIPTION OF THE INVENTION

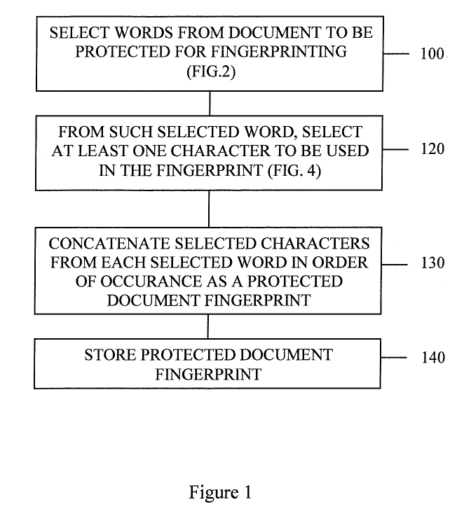

FIG. 1 is a flow chart of a process for creating a documents fingerprint in accordance with one aspect of the invention.

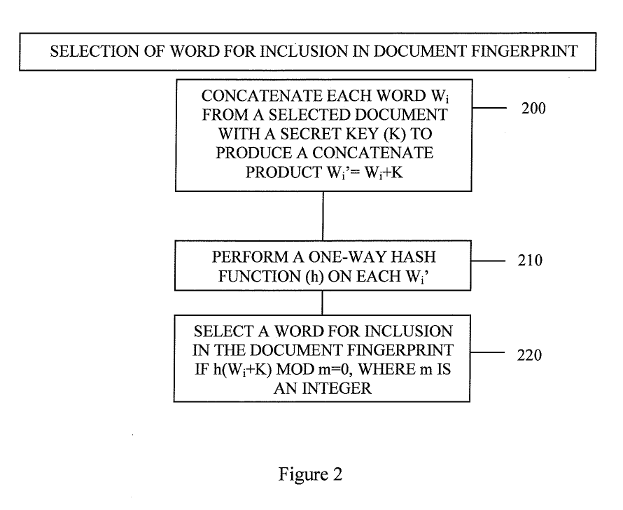

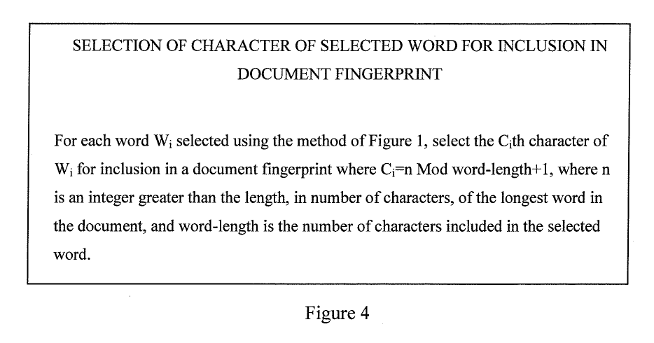

Block 100 represents a process for selecting words from a document to be protected for use in creating a fingerprint. This process is described more in detail in FIG. 2. At step 120, from each selected word, at least one character is selected to be utilized in preparing the document fingerprint. This is described more in conjunction with FIG. 4, below. In step 130, selected characters from each selected word are concatenated in order of occurrence to create a protected document fingerprint. The concatenated characters constituting the document fingerprint are them stored for later use as described hereinafter.

FIG. 2 is a flow chart of a process for selecting a word for use in creating a document fingerprint in accordance with one aspect of the invention. To determine whether a word Wᵢ from a protected text should be selected for inclusion in a process for creating a document fingerprint, that word is first concatenated with a secret key (K) to produce a concatenated product Wᵢ′ which equals Wᵢ+K, where the plus symbol indicates a concatenation operation. This is reflected in step 200.

At step 210, for each word concatenated with a secret key, a one way hash function (H) is applied to the concatenated string Wᵢ′ (210). A word is selected for inclusion in the process of formulating a document fingerprint if:

h(Wᵢ+K) Mod m=0, Equation (1)

where m is an integer.

The significance of the integer m of equation 1 is that it determines a probability of selection of a word or term by controlling the frequency with which words or terms are selected from the text. Thus, if m=5, the probability is approximately 1 divided by 5 that a word will be selected for inclusion in fingerprinting process.

One-way hash functions are well known in the art. Such one-way hash functions include CRC, MD4, MD5, SHA in its various flavors, all of which would conceivably work for this process. However, at the present time, the hash function MD5 is preferred for this application.

The secret key referred to in step 200, is an arbitrary ASCII string. It can be selected by a system administrator. There can in fact be multiple secret keys with resulting different word selections and fingerprints which might be utilized under circumstances where various levels of security protection might be desired. The secret key could be, for example, a clear text phrase selected by the administrator or other person.

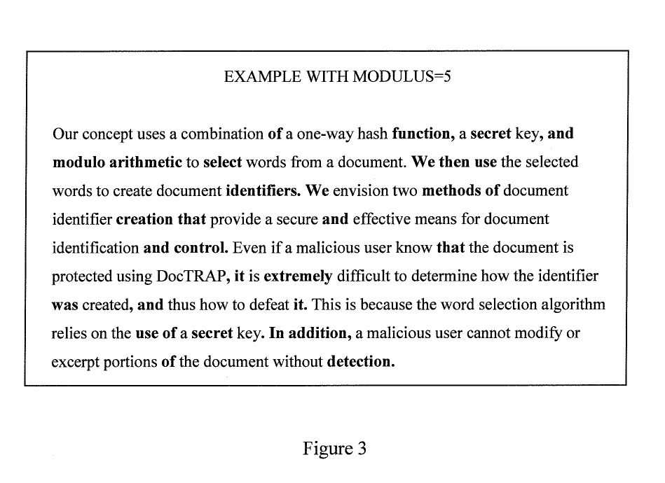

FIG. 3 is an example of words selected from text to be fingerprinted using the process of FIG. 2. The words shown in bold were those selected for further processing to create the document fingerprint. The selection was done in accordance with the process shown in FIG. 2. With the modulus set to modulus=5.

FIG. 4 illustrates the process for selection of a character of a selected word for inclusion in a document fingerprint in accordance with one aspect of the invention. For each word Wᵢ selected using the method of FIG. 1, the Cᵢth character of word Wᵢ is selected for inclusion in a document fingerprint. Cᵢ is determined using:

Cᵢ=n MOD word−length+1 Equation (2)

where n is an integer greater than the length, in number of characters, of the longest word in the document, and word length is the length of the selected word in number of characters.

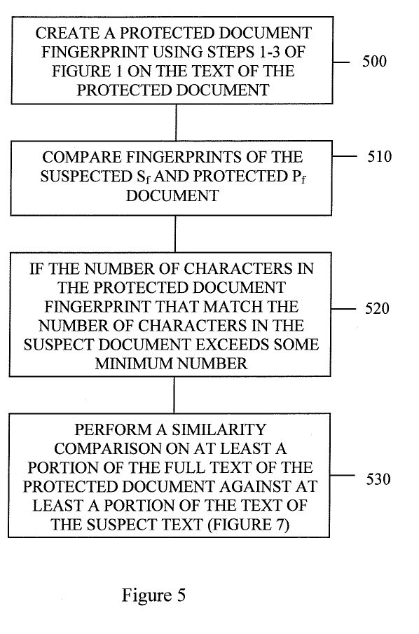

FIG. 5 is a flow chart of a process of identifying whether a document to be screened (suspected document) contains content from a protected document in accordance with one aspect of the invention.

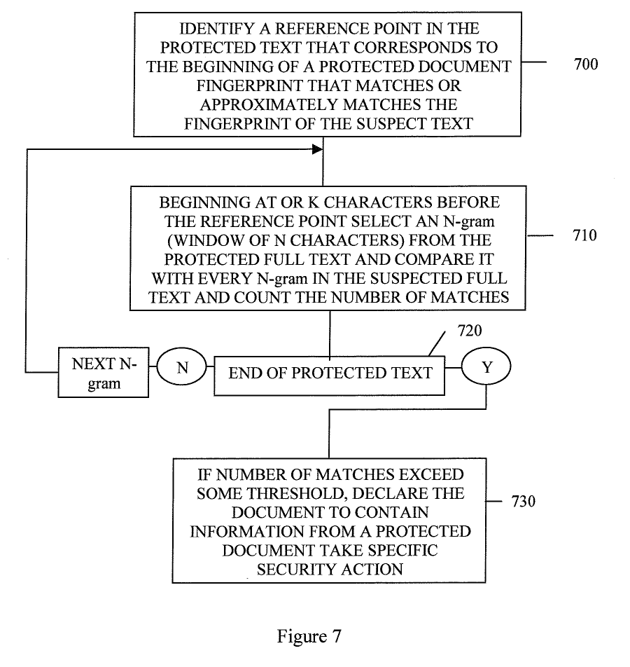

The suspected document is fingerprinted using steps 1-3 of FIG. 1 based on the text of the suspected document (500). The fingerprint of the suspected document S_{f} and protected document P_{f} are compared (510). If the number of characters in the protected document fingerprint match or partially match the number and order of characters in the suspect document (520) then a similarity comparison on at least a portion of the full text of the protected document is made against at least a portion of the text of the suspect document (see FIG. 7). An appropriate action is taken as discussed in conjunction with FIG. 7.

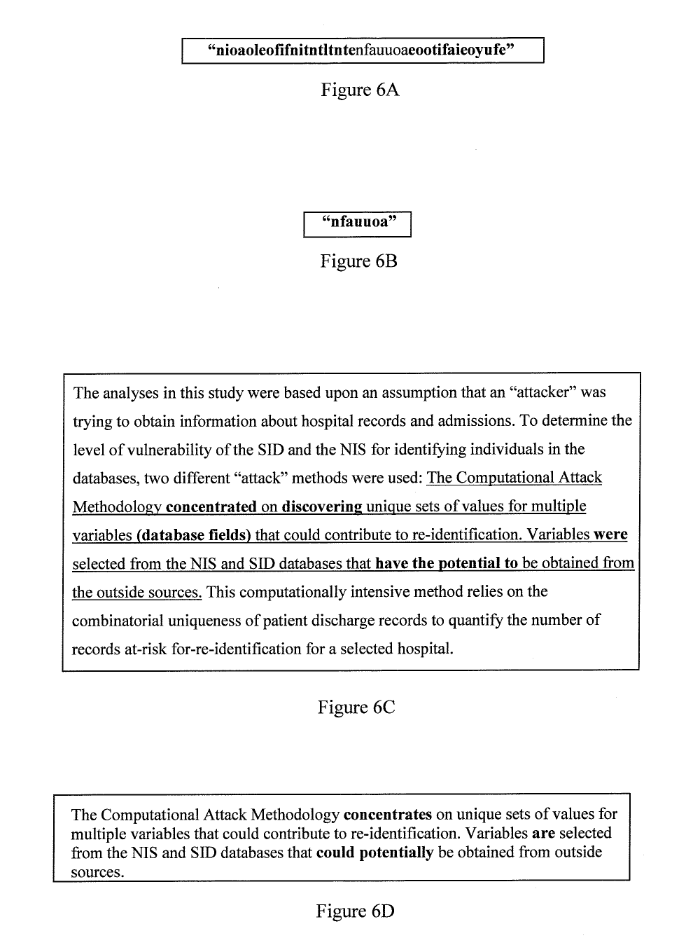

FIGS. 6A and 6B show respective fingerprints from a protected document and a suspected document, respectively. FIGS. 6C and 6D show the full text of a protected document and of a suspected document, respectively. The full text segments of FIGS. 6C and 6D correspond respectively to the fingerprints shown in FIG. 6A and FIG. 6B.

Considering the fingerprint for the suspected text shown in FIG. 6B, when one compares that fingerprint with the fingerprint of the protected text, one sees that the fingerprint from the suspected text is a subset of the fingerprint of the protected text. That difference is emphasized by the portion of the fingerprint for the protected text being displayed without a bold property. When one considers and compares the full protected text shown in FIG. 6C with the full suspected text shown in FIG. 6D, one can determine that although the wording is quite different, the “gist” of the meaning is very similar. It is similar enough that one would wish to enquire further whether or not the suspected text was copied or rephrased from the original protected text.

FIG. 7 is a flow chart of a full text similarity comparison used to confirm whether a suspect document contains sufficient information from a protected document to initiate a human review or to initiate a security action.

The full text comparison starts by identifying a reference point in the protected text that corresponds to the beginning of a protected document fingerprint that matches or approximately matches the fingerprint of the suspect text (700). Beginning at the reference point or q characters before the reference point, and n-gram (window of n characters) from the protected full text is selected and compared with every n-gram in the suspected full text and the number of matches resulting are counted (710).

If the end of the protected text has been reached that is represented by the document fingerprints that are in common between the two documents, if the number of matches exceeds some threshold, (730) the suspect text will be declared to contain information from a protected document and a specified security action will be undertaken. If the end of the protected text that coincides with similar document fingerprints between the two documents has not been reached, the next n-gram will be selected by moving the sliding window one character to the right to select the next n-gram in the sequence of characters from the protected text and the process loops back to repeat step 710.

The security action to be taken mentioned in step 730 may include one or more actions such as (a) notifying a security official; (b) preventing an email from being sent; (c) preventing a document from being printed; (d) preventing packets from being forwarded; (e) preventing copying of the suspect document to a removable medium; (f) performing a text comparison of at least a portion of the text of the protected document with the text of a suspect document; and (g) notifying a user of suspected plagiarism. In short, any number of actions can be taken including both automated and human steps to ensure that the electronic document does not go outside the authorized space with a trusted employee.

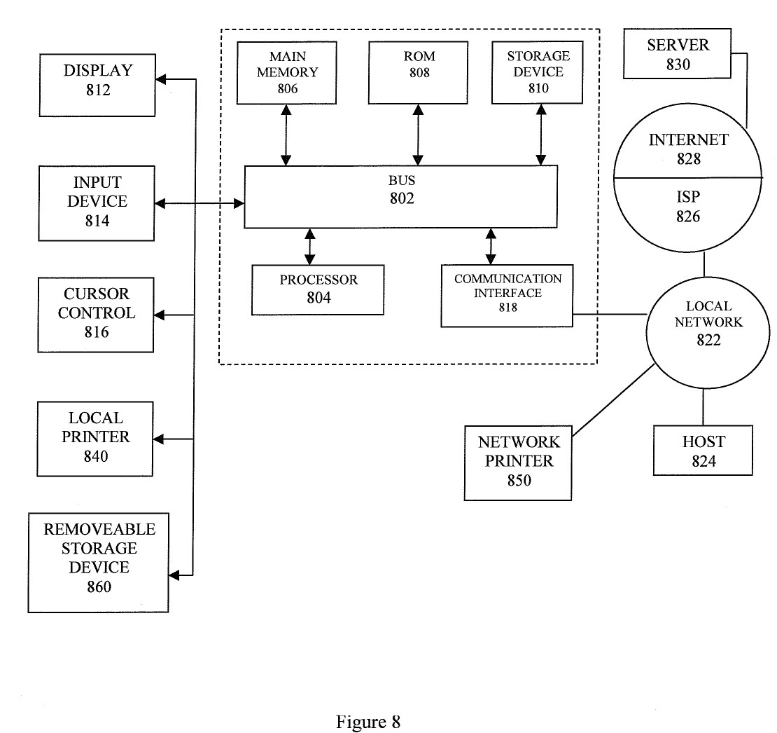

FIG. 8 is a block diagram of an exemplary computing device used as part of a network architecture used in various embodiments of the invention. At least portions of the invention are intended to be implemented on or over a network such as the Internet. An example of such a network is described in FIG. 8, attached.

FIG. 8 is a block diagram that illustrates a computer system 800 upon which an embodiment of the invention may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 operates in response to processor 804 executing one or more sequences of one or more instructions contained in main memory 806. Such instructions may be read into main memory 806 from another computer-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 126 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818. The received code may be executed by processor 804 as it is received, and/or stored in storage device 810, or other non-volatile storage for later execution. In this manner, computer system 800 may obtain application code in the form of a carrier wave.

While various embodiments of the present invention have been illustrated herein in detail, it should be apparent that modifications and adaptations to those embodiments may occur to those skilled in the art without departing from the scope of the present invention as set forth in the following claims.

1. A method for protecting electronic documents, comprising the steps of:
a. selecting words from a document to be protected;
b. selecting at least one character from each word selected;
c. using selected characters to form a protected document fingerprint; and
d. forming a fingerprint from text of a suspect document that might contain content from a protected document; and
e. identifying the suspect document as likely containing text from said protected document when a comparison of the suspect document fingerprint matches at least part of a protected document fingerprint.

2. The method of claim 1, in which a full text comparison between at least a portion of text of the protected document and at least a portion of text from the suspect document occurs if the suspect document is identified as likely containing text from said protected document.

3. The method of claim 2 in which said full text comparison is made by counting the number of n-grams from the protected document that match n-grams take from said protected document.

4. The method of claim 3 in which n-grams from the protected document for the comparison are selected using a sliding window.

5. The method of claim 1 in which the words selected from the document to be protected are selected when h(wᵢ+K) mod m=p, where
h is a one way hash function, and
wᵢ is a word being considered for selection, and
K is a secret key; and
m is an integer specifying a frequency of work selection, and
p is an integer.

6. The method of claim 5, in which the one way hash function is MD5.

7. The method of claim 5 in which p=0.

8. The method of claim 1 in which characters are selected from selected words by selecting the Cth character of the selected word where
C=n mod (word-length)+1, where
N is a integer greater than the length, in characters, of the longest word in the document and
word-length is the number of characters included in the selected word.

9. The method of claim 8 in which a fingerprint is formed by concatenating selected characters from selected words to form a fingerprint.

10. The method of claim 1 in which a security action is taken when the suspect document likely contains text from the protected document.

11. Apparatus for protecting electronic documents, comprising;
a. a computing element for selecting words from a document to be protected and for selecting at least one character from each selected word and for creating a protected document fingerprint from the characters selected;
b. an element for reading electronic text of a suspect document and for detecting similarities between the protected document fingerprint and a fingerprint of the suspect document; and
c. taking a security action when the similarities exceed a specified threshold.

12. Apparatus of claim 11 in which the security action is one or more of:
a. notifying a security official;
b. preventing an email from being sent;
c. preventing a document from being printed;
d. preventing packets from being forwarded;
e. preventing copying of the suspect document to a removable medium;
f. performing a text comparison of at least a portion of the text of the protected document with the text of a suspect document; and
g. notifying a user of suspected plagiarism.

13. A computer program product, comprising:
a. a memory medium;
b. instructions for controlling operation of a computing element, to cause said computing element to:
b1. select words from a document to be protected;
b2. select at least one character from each word selected;
b3. use selected characters to form a protected document fingerprint;
b4. form a fingerprint from text of a suspect document that might contain content from a protected document; and
b5. identify the suspect document as likely containing text from said protected document when a comparison of the suspect document fingerprint matches at least part of a protected document fingerprint.

14. The computer program product of claim 13 in which the memory medium also stores at least one of a print driver, a driver for a removable storage medium, an email client a browser, a communication driver and routing control software.

15. The computer program product of claim 13 in which the instructions for controlling the operation of a computing element cause the element to take a security action when the similarities exceed a specified threshold.

16. The computer program product of claim 15 in which the security action is one or more of:
a. notifying a security official;
b. preventing an email from being sent;
c. preventing a document from being printed;
d. preventing packets from being forwarded;
e. preventing copying of the suspect document to a removable medium;
f. performing a text comparison of at least a portion of the text of the protected document with the text of a suspect document; and
g. notifying a user of suspected plagiarism.

17. A system comprising:
a. a network;
b. one or more computing elements connected to a network;
c. at least one of said computing elements selecting words from a document to be protected and for selecting at least one character from each selected word and for creating a protected document fingerprint from the characters selected, reading electronic text of a suspect document and for detecting similarities between the protected document fingerprint and a fingerprint of the suspect document; and taking a security action when the similarities exceed a specified threshold.

18. The system of claim 17 in which the security action is one or more of:
a. notifying a security official;
b. preventing an email from being sent;
c. preventing a document from being printed;
d. preventing packets from being forwarded;
e. preventing copying of the suspect document to a removable medium;
f. performing a text comparison of at least a portion of the text of the protected document with the text of a suspect document; and
g. notifying a user of suspected plagiarism.
